(19) United States
(12) Patent Application Publication
(10) Pub. No.: US 2018/0323447 A1
(43) Pub. Date: Nov. 8, 2018

(54) TITANIUM PRODUCT, SEPARATOR AND POLYMER ELECTROLYTE FUEL CELL

(71) Applicant: NIPPON STEEL & SUMITOMO METAL CORPORATION, Tokyo (JP)

(72) Inventors: Junko IMAMURA, Tokyo (JP); Jun MAKI, Tokyo (JP); Koichi NOSE, Tokyo (JP); Hideya KAMINAKA, Hyogo (JP)

(21) Appl. No.: 15/772,627

(22) PCT Filed: Nov. 8, 2016
(86) PCT No.: PCT/JP2016/083134

§ 371 Date: May 1, 2018

(30) Foreign Application Priority Data
Nov. 10, 2015 (JP) 2015-220644

(51) Int. Cl. H01M 8/0245; H01M 8/0232; C22C 14/00

(52) U.S. Cl. CPC H01M 8/0245; H01M 2008/1095; C22C 14/00; H01M 8/0232

(57) ABSTRACT

This titanium product includes a base metal, and a complex oxide film formed on the surface of the base metal. The base metal has a chemical composition consisting of, by mass %, platinum group elements: 0 to 0.15%, rare earth elements: 0 to 0.1%, and a balance: Ti and impurities. The complex oxide film contains a complex oxide of Ti and one or more elements selected from La, Ce, Nd, Sr and Ca, and has a thickness of 1 to 20 nm. The average grain size at the base metal surface is preferably from 20 to 300 μm.

### TECHNICAL FIELD

The present invention relates to a titanium product, a separator and a polymer electrolyte fuel cell.

### BACKGROUND ART

A fuel cell utilizes the energy generated in the binding reaction between hydrogen and oxygen, and therefore it is expected that the future will see the widespread introduction and use of fuel cells from the viewpoints of both energy saving and environmental protection measures. Various kinds of fuel cells are available such as a solid electrolyte type, a molten carbonate type, a phosphoric acid type, and a polymer electrolyte type.

Among the different types of fuel cells, the polymer electrolyte fuel cell provides a high output density, is capable of being downsized, operates at a lower temperature than other types of fuel cells, and is easy to start and stop. Because of such advantages, the polymer electrolyte fuel cell is expected to be used for automobiles and small-sized cogeneration systems for domestic use and the like, and the polymer electrolyte fuel cell, in particular, has been drawing attention in recent years.

FIG. 1A is a perspective view of a polymer electrolyte fuel cell (hereinafter, may simply be referred to as “fuel cell”), and FIG. 1B is an exploded perspective view of a single cell that is used in the fuel cell.

As illustrated in FIG. 1A, a fuel cell 1 is an assembly (stack) of single cells. As illustrated in FIG. 1B, in a single cell, an anode-side gas diffusion electrode layer (also called “fuel electrode film”; hereinafter, referred to as “anode”) 3 is laminated on one surface of a solid polymer electrolyte membrane 2, a cathode-side gas diffusion electrode layer (also called “oxidant electrode film”; hereinafter, referred to as “cathode”) 4 is laminated on the other surface of the solid polymer electrolyte membrane 2, and separators (bipolar plates) 5a and 5b are overlaid on both surfaces of the stacked structure, respectively.

Some of fuel cells include separators that have a circulation path of cooling water and the separators are arranged between two adjacent single cells or on every several single cells. The present invention is directed to a separator for such kind of water-cooled fuel cell and also to a titanium product to be used in the separator.

As the solid polymer electrolyte membrane (hereinafter, simply referred to as “electrolyte membrane”) 2, a fluorine-based proton-conducting membrane having a hydrogen ion (proton) exchange group is mainly used.

Both the anode 3 and the cathode 4 are formed mainly of a carbon sheet in which carbon fiber having electrical conductivity is processed in a sheet form (or of carbon paper that is thinner than a carbon sheet, or of an even thinner carbon cloth). The anode 3 and the cathode 4 may be provided with a catalyst layer made of a particulate platinum catalyst, graphite powder, and as necessary a fluorine resin having a hydrogen ion (proton) exchange group.

In the separator 5a, groove-like flow channels 6a are formed on the surface on the anode 3 side. A fuel gas (hydrogen or a hydrogen-containing gas) A is passed through the flow channels 6a to supply hydrogen to the anode 3. In the separator 5b, groove-like flow channels 6b are formed on the surface on the cathode 4 side. An oxidizing gas B such as air is passed through the flow channels 6b to supply oxygen to the cathode 4. By the supply of these gases, an electrochemical reaction is produced and direct current power is generated. In a case where a catalyst layer is provided in the anode 3 and the cathode 4, the fuel gas or the oxidizing gas and the catalyst layer come into contact, and reaction thereof is promoted.

The principal functions required for the separator of a polymer electrolyte fuel cell are as follows:

(1) a function as a “flow channel” which supplies a fuel gas or an oxidizing gas uniformly into the surface of a cell;

(2) a function as a “flow channel” which efficiently discharges water generated on the cathode side, together with a carrier gas such as air or oxygen after reaction, from the fuel cell to outside of the system;

(3) a function of being in contact with the electrode film (anode 3 or cathode 4) to form a path for electricity, and further serving as an electrical “connector” between two single cells that are adjacent;

(4) a function as a “diaphragm” between adjacent cells, that is, between the anode chamber of one cell and the cathode chamber of an adjacent cell; and (5) in a water-cooled fuel cell, a function as a “diaphragm” between a cooling-water flow channel and an adjacent cell.

The matrix material of the separator used for a polymer electrolyte fuel cell (hereinafter, simply referred to as “separator”) needs to be one that can achieve such functions. The kinds of matrix material are roughly categorized into metal-based materials and carbon-based materials.

A separator made of a carbon-based material is produced by a method in which a graphite substrate is impregnated with a thermosetting resin such as a phenol-based resin or a furan-based resin and curing and firing are performed, or a method in which carbon powder is kneaded with a phenol resin, a furan resin, tar pitch, or the like, the resulting material is press-formed or injection-molded into a sheet shape and firing is performed to produce glassy carbon, or by a similar method. Since the specific gravity of a carbon-based material is low, when a carbon-based material is used there is the advantage that a lightweight separator is obtained. However, such kinds of separators have problems in that the separator has gas permeability and in that the mechanical strength is low.

Examples of the metal-based materials that are used include titanium, stainless steel, carbon steel, and the like. Separators made of these metal-based materials are produced by press working or the like. A metal-based material has, as characteristics peculiar to metal, the advantage of being excellent in workability, the advantage that the thickness of the separator can be made thin, and the advantage that the weight of the separator can be reduced. However, when a metal-based material is used, the electrical conductivity may be reduced due to oxidation of the metal surface. Therefore, there is a problem in that the contact resistance between a separator made of a metal-based material and an electrode film may increase. To address this problem, the following measures have been proposed.

Patent Document 1 proposes a process in which, in a separator matrix made of titanium, a passivation film is removed from a surface that is to be in contact with the electrode, and the surface is then plated with a noble metal such as gold. Patent Document 2 proposes a titanium alloy in which an increase in contact resistance is suppressed by pickling a titanium alloy containing one or more platinum group elements to thereby cause the platinum group elements to concentrate on the surface. Further, Patent Document 3 proposes a separator made of titanium in which platinum group elements are concentrated on the surface by pickling, and a heat treatment is then performed in a low oxygen concentration atmosphere for the purpose of improving the adhesiveness between the platinum group elements concentrated on the surface and the matrix.

Patent Document 4 proposes a method in which, with respect to a metal separator having a surface made of titanium, an electrically conductive contact layer made of carbon is formed on the surface by vapor deposition. Patent Document 5 proposes a titanium product for a separator that has a film made from titanium compound particles and titanium oxide on the surface. The titanium compound is a compound of titanium and at least one of carbon and nitrogen. Further, Patent Document 6 proposes a titanium product for a polymer electrolyte fuel cell separator that has good electrical conductivity which is obtained by platinum group elements being exposed and concentrated to a high concentration on the surface.

### LIST OF PRIOR ART DOCUMENTS

### Patent Document

Patent Document 1: JP2003-105523A

Patent Document 2:N2006-190643A

Patent Document 3: JP2007-59375A

Patent Document 4: JP2004-158437A

Patent Document 5: WO 2011-016465

Patent Document 6: JP2013-109891A

### SUMMARY OF INVENTION

### Technical Problem

Polymer electrolyte fuel cells are expected to be widely used as fuel cells for movable bodies and as stationary fuel cells. Therefore, there are problems from the viewpoints of economic efficiency and the amount of available resources in the case of the technology disclosed in Patent Document 1 in which a large amount of a noble metal is used in a fuel cell. Further, the separators disclosed in Patent Documents 2 and 3 each contain platinum group elements, and the number of man-hours during production is large, and consequently, a large cost increase cannot be avoided.

In Patent Document 4, an attempt is made to solve the problem of an increase in contact resistance, without using a noble metal. However, usually a titanium oxide film that does not have electrical conductivity is formed on the surface of titanium. Therefore, the contact resistance is not reduced even when an electrically conductive contact layer is formed on the aforementioned film. To reduce the contact resistance, it is necessary to form an electrically conductive contact layer immediately after the aforementioned titanium oxide film is removed. In order to perform such a treatment, it is necessary to control the atmosphere and the like when performing the treatment, and a large cost increase cannot be avoided.

The film disclosed in Patent Document 5 has a structure in which titanium compounds are dispersed in a titanium oxide film, and it is intended to ensure electrical conductivity by means of the titanium compounds. However, in the separator disclosed in Patent Document 5, it is difficult to secure sufficient electrical conductivity due to the small size of the conducting area, and there remains room for improvement.

In Patent Document 6, it is possible to maintain low contact resistance by causing platinum group elements to concentrate on the titanium product surface. However, such a coating that is formed on the titanium product surface requires melting of a large amount of the base-metal titanium matrix for the surface concentration of platinum group elements which are of a small content, and there remains room for improvement with respect to reducing the contact resistance.

In general, the contact resistance between the separator and the electrode film is also increased by a fluoride being formed on the surface of the separator. In the fuel cell, fluoride ions are produced from the electrolyte membrane 2, while on the other hand water is produced by the reaction of the fuel cell. By this means, hydrogen fluoride water is produced, and when a voltage is applied between the electrolyte membrane 2 and the separators 5a and 5b in this state, fluoride is formed on the surface of the separator.

An objective of the present invention is to solve the foregoing problems of the prior art, and provide a titanium product for which initial contact resistance is low and which has favorable corrosion resistance in an environment inside a polymer electrolyte fuel cell, and therefore maintains a low contact resistance, as well as a separator and a polymer electrolyte fuel cell.

### Solution to Problem

The present invention was made to solve the problems described above, and the gist of the present invention is a titanium product, a separator and a polymer electrolyte fuel cell that are described hereunder.

(1) A titanium product, including:

a base metal having a chemical composition consisting of, by mass %,

platinum group elements: 0 to 0.15%,

rare earth elements: 0 to 0.1%, and

a balance: Ti and impurities; and

a complex oxide film formed on a surface of the base metal, the film containing a complex oxide of Ti and one or more elements selected from La, Ce, Nd, Sr and Ca, and having a thickness of 1 to 20 nm.

(2) The titanium product according to (1) above, wherein

the chemical composition of the base metal contains, by mass %,

the platinum group elements: 0.005 to 0.15%.

(3) The titanium product according to (1) or (2) above, wherein

the chemical composition of the base metal contains, by mass %,

the rare earth elements: 0.005 to 0.1%.

(4) The titanium product according to any of (1) to (3) above, wherein

an average grain size at the surface of the base metal is 20 to 300 μm.

(5) The titanium product according to any of (1) to (4) above, wherein

the titanium product has, at an outermost layer, a metal layer containing one or more elements selected from Au, Pt, Ag, Pd, Ru and Rh as a main constituent and having a thickness of 2 to 50 nm.

(6) The titanium product according to any of (1) to (4) above, wherein

the titanium product has, at an outermost layer, a conductive carbon layer containing conductive carbon as a main constituent and having a thickness of 2 to 50 nm.

(7) A separator for a polymer electrolyte fuel cell, which includes the titanium product according to any of (1) to (6) above.

(8) A polymer electrolyte fuel cell, which includes the separator according to (7) above.

### Advantageous Effects of Invention

According to the present invention, a titanium product for which initial contact resistance is low and which has favorable corrosion resistance in an environment inside a polymer electrolyte fuel cell can be obtained. Therefore, when a separator containing the titanium product according to the present invention is used for a polymer electrolyte fuel cell, it is possible to maintain low contact resistance.

### BRIEF DESCRIPTION OF DRAWINGS

FIG. 1A is a perspective view that schematically illustrates the structure of a polymer electrolyte fuel cell.

FIG. 1B is an exploded perspective view that illustrates the structure of a single cell constituting part of the polymer electrolyte fuel cell.

FIG. 2 is a schematic cross-sectional diagram of a titanium product according to one embodiment of the present invention.

FIG. 3 is a view far describing a method for measuring contact resistance.

### DESCRIPTION OF EMBODIMENTS

1. Titanium Product

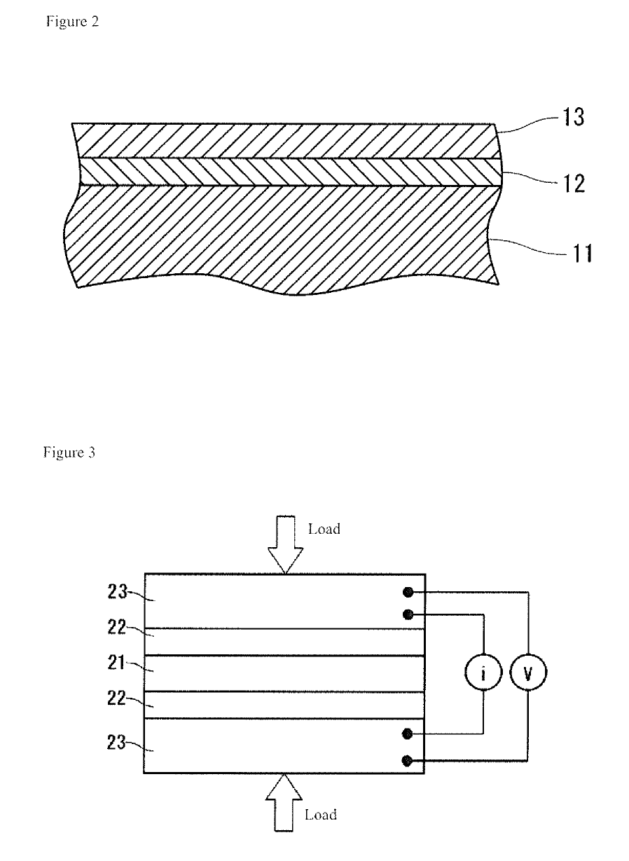

FIG. 2 is a schematic cross-sectional diagram of a titanium product according to one embodiment of the present invention. A complex oxide film 12 is formed on the surface of a base metal 11. Further, a metal layer or a conductive carbon layer 13 is formed on the complex oxide film 12. The respective constituent requirements of the present invention are described in detail hereunder.

(A) Chemical Composition of Base Metal

The base metal has a chemical composition that contains, as required, platinum group elements and rare earth elements, with a balance being Ti and impurities. The reasons for limiting each element are as follows. Note that, “%” with respect to content in the following description means “mass percent”.

Platinum group elements: 0 to 0.15%

Platinum group elements have an electrical resistivity lower than that of titanium, are resistant to oxidation and corrosion in polymer electrolyte fuel cell operating environments, and do not cause an increase in electrical resistivity. Further, by containing platinum group elements in the base metal, the corrosion resistance of the base metal itself improves, and it becomes difficult for a titanium oxide film to be formed on a near-surface portion of the base metal. Therefore, platinum group elements may be contained as required.

However, if the content of platinum group elements is more than 0.15%, the aforementioned effects are saturated and the raw material cost also increases. Therefore, the content of platinum group elements is made not more than 0.15%. When taking into consideration the balance between economic efficiency and corrosion resistance, the content of platinum group elements is preferably made 0.1% or less. To adequately obtain an effect that increases the corrosion resistance of the base metal and an effect that suppresses formation of a titanium oxide film, the content of platinum group elements is preferably made 0.005% or more, and more preferably is made 0.02% or more.

Herein, “platinum group elements” refers to ruthenium (Ru), rhodium (Rh), palladium (Pd), osmium (Os), iridium (Ir) and platinum (Pt). The base metal may substantially contain only one kind of platinum group element, or may contain a plurality of kinds of platinum group elements. The aforementioned content of platinum group elements means the total content of these elements.

Rare earth elements: 0 to 0.1%

If the base metal contains rare earth elements, even if the content of platinum group elements in the base metal is made low, corrosion resistance and surface conductivity that are equivalent to those of a titanium product containing a higher amount of platinum group elements are obtained. Therefore, rare earth elements may be contained as required.

However, if the content of rare earth elements is more than 0.1%, even if misch metal is used as the rare earth elements, the raw material cost will increase. Therefore, the content of rare earth elements is made 0.1% or less. The content of rare earth elements is preferably 0.08% or less. To obtain the aforementioned effects, the content of rare earth elements is preferably made 0.005% or more, and more preferably is made 0.01% or more.

Herein, rare earth elements refer to a total of 17 elements that are scandium (Sc), yttrium (Y) and the lanthanoids. The base metal may substantially contain only one kind of rare earth element, or may contain a plurality of kinds of rare earth elements. The aforementioned content of rare earth element means the total content of these elements.

In the process of producing the base metal, rare earth elements may be added as misch metal to the Ti raw material. Misch metal refers to an alloy that contains a plurality of kinds of rare earth elements, and in many cases mainly contains La and Ce. Because the separating expenses incurred when producing a single kind of rare earth element are not incurred in the case of misch metal, rare earth elements can be contained inexpensively by using misch metal.

Fe: 0.1% or less

In general, the titanium base metal contains Fe as an impurity. Fe has an action that deteriorates the corrosion resistance of the titanium product. Although a particular limit is not set with respect to the Fe content, to increase the corrosion resistance of the titanium product it is preferable to make the Fe content of the base metal low, specifically, it is preferable to make the Fe content 0.1% or less.

(B) Complex Oxide Film

The complex oxide film contains a complex oxide of Ti and one or more elements selected from La, Ce, Nd, Sr and Ca. The presence of the complex oxide can be confirmed by X-ray diffraction measurement. It is preferable that, in the complex oxide film, the total content of one or more elements selected from La, Ce, Nd, Sr and Ca, and Ti and 0 (oxygen) is not less than 90%, and more preferably is not less than 95%.

Because this kind of complex oxide is excellent in electrical conductivity, the surface resistance of the titanium product can be kept low. Examples of the complex oxide that may be mentioned include complex oxides having a perovskite crystalline structure such as LaTiO₃ and CeTiO₃. The complex oxide may have a stoichiometric composition, or may have a nonstoichiometric composition.

Usually, an oxide film is naturally formed on the surface of a titanium product. However, because the electrical conductivity of an oxide of titanium is low, preferably the titanium product of the present invention does not contain titanium oxide as a surface oxide film.

The complex oxide film can be formed, for example, as follows. First, after subjecting the base metal to cold rolling, an aqueous dispersion containing an oxide sol of one or more elements selected from La, Ce, Nd, Sr and Ca is coated onto the surface of the base metal using a roll coater or the like. The base metal is dried in this state, and is thereafter annealed. By this means, the aforementioned oxide and a Ti oxide formed on the surface of the base metal react, and a film containing a complex oxide of Ti and one or more elements selected from La, Ce, Nd, Sr and Ca, that is, a complex oxide film, is formed on the surface of the base metal.

However, because oxides of Sr react with water, it is preferable to use a hydroxide sol or a carbonic acid compound sol for Sr. When using an Sr hydroxide sol or an Sr carbonic acid compound sol also, during the annealing process the hydroxide or carbonic acid compound decomposes to generate water or carbonic acid, resulting in an Sr oxide. In this way, a complex oxide is formed, similarly to when an oxide sol is used.

When performing annealing, if the annealing temperature is too high there is a risk that the crystallinity of the film will increase and the electrical conductivity will decrease. Therefore, it is preferable to make the annealing temperature less than 900° C.

Further, if the thickness of the complex oxide film is less than 1 nm, adequate corrosion resistance will not be obtained. On the other hand, if the thickness of the complex oxide film is more than 20 nm, the surface resistance of the titanium product will be too high. Therefore, the thickness of the complex oxide film is made 1 to 20 nm. The thickness of the complex oxide film is preferably 3 nm or more, and more preferably is 4 nm or more. Further, the thickness of the complex oxide film is preferably not more than 15 nm, and more preferably is not more than 10 nm.

(C) Average Grain Size

A particular limit is not set regarding the average grain size of the base metal. However, if it is attempted to make the thickness of the complex oxide film large, it is necessary to raise the annealing temperature or to lengthen the annealing time period, and as a result the grain size will increase. In particular, if the average grain size in the entire base metal including the base metal surface is more than 300 μm, there is a risk that the ductility of the titanium product will decrease and cracking will easily occur when press forming the titanium product.

On the other hand, if the average grain size at the base metal surface is less than 20 μm, the electrical conductivity of the near-surface portion of the titanium product may decrease. It is considered that this is because oxides of titanium are liable to be formed along the grain boundary of the base metal. That is, it can be interpreted that as the average grain size decreases, the grain boundary area per unit volume increases and oxides on the conductive path increase, and hence the electrical conductivity decreases. Therefore, it is preferable to make the average grain size at the base metal surface 20 to 300 μm.

The average grain size at the base metal surface can be obtained by measuring at a cut surface of the titanium product in the vicinity of an interface with the complex oxide film. Specifically, the length in a direction parallel with the base metal surface of grains that come in contact with the complex oxide film is measured at a plurality of locations in the base metal portion, and a mean value of the lengths is taken as the average grain size.

The average grain size at the titanium product surface can be adjusted by controlling the rolling reduction during cold rolling as well as the temperature and time period of annealing that is performed after cold rolling. The lower the rolling reduction is made, or the higher the annealing temperature is, or the longer the annealing time period is, the greater the average grain size becomes. The cold rolling conditions are the factors that particularly influence the average grain size at the titanium product surface. By making the roll diameter that is used for cold rolling large in addition to making the rolling reduction low, strain in the vicinity of the surface can be suppressed, and the average grain size at the base metal surface can be increased.

(D) Metal Layer and Conductive Carbon Layer

As required, a metal layer or a conductive carbon layer may be provided on the outermost layer of the titanium product. Although the complex oxide film is excellent in electrical conductivity and corrosion resistance, if a metal layer or a conductive carbon layer is provided on the outermost layer of the titanium product, the electrical conductivity and corrosion resistance of the near-surface portion of the titanium product can be further enhanced. Conversely, in a case where the complex oxide film is not present, due to the influence of an oxide film that will be formed on the titanium product surface, it will be difficult for the resistance to decrease even if a metal layer or a conductive carbon layer is provided on the top layer.

The metal layer contains one or more elements selected from Au, Pt, Ag, Pd, Ru and Rh as a main constituent. Here, “contains one or more elements selected from Au, Pt, Ag, Pd, Ru and Rh as a main constituent” means that a proportion that one or more elements selected from Au, Pt, Ag, Pd, Ru and Rh occupies in the metal layer is 90% or more. The metal layer can be formed, for example, by a plating method or an evaporation method by supplying a predetermined metal onto the complex oxide film.

The conductive carbon layer contains conductive carbon as a main constituent. Here, “contains conductive carbon as a main constituent” means that a proportion which conductive carbon occupies in a film layer containing the conductive carbon is 90% or more, and the layer has electrical conductivity. For example, DLC (diamond-like carbon) having electrical conductivity or graphite can be adopted as the conductive carbon. The kinds of DLC include a kind that is crystalline and a kind that is amorphous. Although the usual DLC is an electrical insulator, DLC that has electrical conductivity also exists. In the case of using DLC for the conductive carbon layer, the DLC that has electrical conductivity is to be used. Because graphite has a layered crystalline structure, if graphite receives stress, peeling can occur between layers. In contrast, because the mechanical properties of DLC are isotropic, it is difficult for peeling to occur within grains as long as a particularly strong force is not applied. The conductive carbon layer can be formed, for example, by supplying carbon onto the complex oxide film by an evaporation method.

A thickness of 2 to 50 nm is preferable for the metal layer and the conductive carbon layer, respectively. If the thickness is less than 2 nm, an effect that enhances the electrical conductivity and that enhances the corrosion resistance of the titanium product surface will be difficult to obtain. To adequately obtain the aforementioned effect, the thickness of the metal layer or the conductive carbon layer is preferably 2 nm or more. If the thickness is more than 50 nm, the production cost will noticeably increase. To keep down the production cost, the thickness of the metal layer or the conductive carbon layer is preferably made not more than 40 nm.

In the complex oxide film, it is difficult for corrosion products to be formed at a portion covered by the metal layer or conductive carbon layer. Therefore, in the environment inside a fuel cell, it is easy to maintain an electrical connection through the aforementioned portion. By this means, the contact resistance as the entire titanium product with respect to the electrode film is easily maintained at a low contact resistance.

The coverage factor of the metal layer or conductive carbon layer (proportion of the area of the portion covered by the metal layer or conductive carbon layer with respect to the surface area of the titanium product; hereunder, referred to simply as “coverage factor”) is most preferably 100%. However, when the thickness of the metal layer or conductive carbon layer is small, it is difficult to cover the whole area of the complex oxide film. Even when the coverage factor is around 30%, the aforementioned effect of maintaining a low contact resistance is obtained. If the coverage factor is 50% or more, this effect is stably obtained.

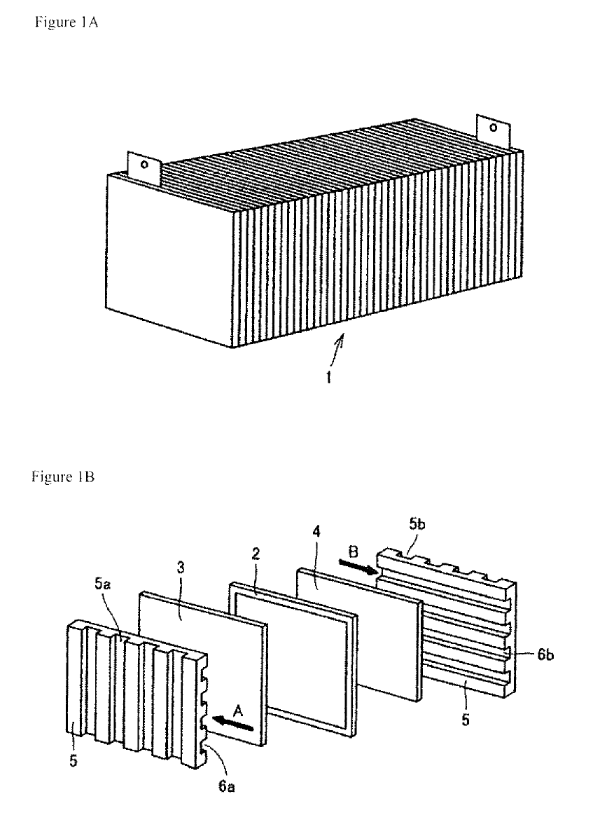

The surface of the titanium product may be flat or may be caused to have moderate roughness. Moderate roughness means, for example, that the surface roughness is a value of approximately 1 to 2 μm with respect to the arithmetic average roughness Ra defined in JIS 13 0601 (2001). If the surface of the titanium product is rough, when the anode 3 or the cathode 4 (see FIG. 1B) is brought in contact with the surface, interfacial pressure in the vicinity of convex parts of the surface increases, and electric conduction in those regions is facilitated. Such kind of rough surface can be obtained, for example, by treating the base metal with an acid treatment liquid containing hydrofluoric acid. In this case, the complex oxide film is formed after performing the treatment using the acid treatment liquid. The surface roughness of the titanium product is preferably an Ra value of 1.1 to 1.5 μm.

2. Separator

The separator of the present invention can be used in a polymer electrolyte fuel cell. The separator contains the titanium product of the present invention. Therefore, in the polymer electrolyte fuel cell, the separator exhibits excellent corrosion resistance, and low contact resistance can be maintained.

The separator of the present invention can be produced by forming a complex oxide film on the surface of a tabular base metal by the aforementioned method, and thereafter forming groove-like flow channels by press working. The complex oxide film may also be formed after subjecting the tabular base metal to press working. In the case of roughening the surface roughness of the titanium product, the aforementioned treatment using an acid treatment liquid is performed at a time that is after press working and before forming the complex oxide film. Further, in the case of producing a separator containing a titanium product in which a metal layer or a conductive carbon layer is provided on the outermost layer, after formation of the complex oxide film and press forming, the metal layer or conductive carbon layer is formed by the aforementioned method.

In a case where the base metal does not substantially contain platinum group elements, when incorporating the separator into a fuel cell, in some cases the metal layer or conductive carbon layer may peel off or locally float up from the complex oxide film. In such a case, in the environment inside the fuel cell in which fluoride ions are present, the corrosion resistance of the titanium product decreases and the contact resistance increases.

In contrast, when the base metal contains platinum group elements, the metal layer or conductive carbon layer firmly adheres to the complex oxide film, and when incorporating the separator into a fuel cell, peeling off or localized floating up of the metal layer or conductive carbon layer can be suppressed. By this means, the corrosion resistance of the titanium product can be maintained at a high level and the contact resistance can be maintained at a low level.

Hereunder, the present invention is more specifically described with reference to Examples, but the present invention is not limited to these Examples.

### EXAMPLES

### Example 1

To verify the effect of the present invention, test samples of titanium products were prepared and evaluated by the following methods.

1. Preparation of Titanium Products

As the starting materials for producing the titanium products, titanium ingots were prepared that were obtained by melting and solidifying raw materials at the laboratory level. The chemical compositions of the starting materials (ingots) are shown in Table I.

TABLE 1

Chemical composition (by mass %,
balance: Fe and impurities)

| | Platinum | | | | |
|---|---|---|---|---|---|
| Raw | group | Rare earth | | | |
| material | elements | elements | Fe | O | C |
| A | ND | ND | 0.03 | 0.03 | 0.003 |
| B | Pd:0.04 | ND | 0.02 | 0.06 | 0.002 |
| C | Ru:0.05 | 0.01 | 0.04 | 0.06 | 0.003 |
| D | Ir:0.07 | 0.03 | 0.04 | 0.04 | 0.003 |
| E | Ru:0.06 | 0.09 | 0.03 | 0.05 | 0.004 |
| F | Ir:0.05 | 0.11 | 0.04 | 0.04 | 0.003 |
| G | Pt:0.10 | ND | 0.03 | 0.03 | 0.003 |
| H | Pd:0.13 | ND | 0.03 | 0.03 | 0.004 |

These ingots were sequentially subjected to hot rolling and cold rolling to obtain titanium sheets having a thickness of 0.1 mm as the base metal. A work roll having a diameter of 800 mm was used for the cold rolling. The rolling reduction in the cold rolling was set to 50 to 80%.

Next, aqueous dispersions of sols of each of La₂O₃, CeO₂, Nd₂O₃, Sr (OH) and CaO were applied by a roll coater method to both sides of the titanium sheets. As a comparison, a titanium sheet onto which an Al₂O₃ sol aqueous dispersion was applied was also prepared. The applied amount of the sol aqueous dispersion was, for each titanium sheet, 0.1 g/m² per side, as the mass of the compound (oxide or hydroxide). Thereafter, the titanium sheets were annealed to obtain test samples of the titanium products. The annealing temperature was set to 700 to 930° C., and the annealing atmosphere was made a gaseous mixture containing 95 vol % nitrogen and 5 vol % hydrogen.

The obtained titanium products were subjected to press working to form groove-like gas flow channels having a width of 2 mm and a depth of 1 mm on both sides of the titanium product (corresponding to anode side and cathode side of separators 5a and 5b), thereby making the titanium products into a form that could be used as a separator.

2. Evaluation of Titanium Products

(1) Measurement of Average Grain Size of Base Metal

The base metal after annealing was cut and a sheet-thickness cross section was polished, and the lengths of grains in a base metal portion contacting the complex oxide film were measured in a region extending to 200 μm. The average grain size was calculated by averaging the obtained lengths.

(2) Identification of Substance Formed on Surface, and Measurement of Thickness of Film that the Substance was Formed

A thin film X-ray diffraction method was used to obtain an X-ray diffraction pattern with respect to the titanium products after annealing, and substances formed in a film on the surface of the titanium products were identified. The irradiation angle of the X-rays was 5°. In the case of titanium products for which the film thickness was particularly thin, measurement was performed in which the sensitivity was raised by adopting an in-plane method. Further, a small piece including a cross-section perpendicular to the surface was cut out from each of the titanium products, and the small piece was made into a thin film by FIB processing. An FE-TEM image of the thin film was obtained, and the thickness of the surface film was measured. For each titanium product, the thickness of the surface film was measured in three visual fields, and the average value of the measured values was taken as the thickness of the surface film formed on the relevant titanium product.

(3) Contact Resistance Measurement Method

The contact resistance was measured using an apparatus that is schematically illustrated in FIG. 3. Specifically, first, a prepared titanium product (hereinafter, referred to as “titanium separator”) 21 was sandwiched between a pair of sheets of carbon paper 22 (TGP-H-90 manufactured by Toray Industries, Inc.) used as gas diffusion layers (the anode 3 and the cathode 4 of FIG. 1B), and the resulting structure was then sandwiched between a pair of gold-plated electrodes 23. The area of each of the sheets of carbon paper 22 was 1 cm².

Next, a load was applied across the pair of electrodes 23, and in this state a certain current was passed between the electrodes 23 and the voltage drop between the carbon papers 22 and the titanium separator 21 that arose at this time was measured, and the resistance value was determined based on the result. The resistance value was measured taking the load as 5 kgf/cm² (4.9×10⁵ Pa). Since the obtained resistance value was the value of the sum of the contact resistances of both surfaces of the titanium separator 21, the value was divided by 2 and the result was adopted as the contact resistance value per surface of the titanium separator 21 (initial contact resistance).

Next, using the titanium separator whose initial contact resistance had been measured, a single-cell polymer electrolyte fuel cell was fabricated and the contact resistance after operation of the fuel cell was measured. That is, the fuel cell into which the separator was incorporated and which was then operated was not a fuel cell formed by stacking multiple single cells. This is because, in the case of fuel cells in a state in which single cells are stacked, differences in the stacking states are reflected in the evaluation results, and the reproducibility of the measurement values is low. In the cell, FC50-MEA (uses Nation (registered trademark) −1135 as an ion-exchange membrane) which is a standard MEA for PEFCs that is manufactured by TOYO Corporation was used as the membrane electrode assembly (MEA) including a solid polymer electrolyte membrane.

Hydrogen gas with a purity of 99.9999% was fed into the fuel cell as gas for use as the anode-side fuel, and air was fed as the cathode-side gas. The pressure of the hydrogen gas and the air when introduced into the fuel cell was set to 0.04 to 0.20 bar (4000 to 20000 Pa). The entire fuel cell body was maintained at a temperature of 70±2° C., and the humidity inside the fuel cell was controlled by setting the entry-side dew point to 70° C. The pressure inside the cell was approximately 1 atmosphere (approximately 1.01×10⁵ Pa).

The fuel cell was operated at a constant current density of 0.5 A/cm². The output voltage was highest during a period from 20 to 50 hours after the start of operation. The operation was continued for 500 hours after reaching the highest voltage, and thereafter operation of the fuel cell was stopped. The cell was then disassembled and the separator taken out, and the contact resistance was measured by the method described above and the obtained value was taken as the contact resistance after electricity generation operation.

A digital multimeter (KEITHLEY 2001, manufactured by TOYO Corporation) was used for measurement of the contact resistance and for measurement of the current and voltage during operation of the fuel cell.

Table 2 shows the production conditions of the titanium products and the evaluation results. The meanings of the symbols shown in the “Overall evaluation” column in Table 2 are as follows.

◯: Initial contact resistance was 10 mΩ·cm² or less, contact resistance after battery operation was 20 mΩ·cm² or less, and titanium product was excellent in press-formability.

×: Initial contact resistance was more than 10 mΩ·cm², or contact resistance after battery operation was more than 20 mΩ·cm², or press-formability was poor.

Here, “excellent in press-formability” means that cracks did not arise during press working to form groove-like gas flow channels.

[Table 2]

TABLE 2

| | | | | | | | | Contact resistance | | | |
|---|---|---|---|---|---|---|---|---|---|---|---|
| | | Rolling | Annealing | Grain size | | | Film | (mΩ · cm²) | | | |
| Test | Raw | reduction | temperature | at surface | Coated | Substance | thickness | | After | Overall | |
| No. | material | (%) | (° C.) | (μm) | compound | in film | (nm) | Initial | operation | evaluation | |
| 1 | A | 80 | 820 | 23 | La₂O₃ | LaTiO₃ | 5 | 8.5 | 11.3 | ∘ | Inventive |
| 2 | B | 80 | 860 | 37 | CeO₂, La₂O₃ | (Ce, La)TiO₃ | 9 | 7.9 | 10.7 | ∘ | example |
| 3 | C | 70 | 840 | 55 | Nd₂O₃ | NdTiO₃ | 7 | 7.7 | 11.0 | ∘ | |
| 4 | D | 70 | 880 | 81 | Sr(OH)₂, La₂O₃ | (Sr, La)TiO₃ | 11 | 7.8 | 11.8 | ∘ | |
| 5 | E | 60 | 890 | 148 | CaO | CaTiO₃ | 13 | 8.2 | 12.0 | ∘ | |
| 6 | F | 60 | 750 | 27 | Nd₂O₃ | NdTiO₃ | 2 | 7.2 | 11.0 | ∘ | |
| 7 | G | 50 | 770 | 35 | La₂O₃ | LaTiO₃ | 3 | 7.5 | 10.5 | ∘ | |
| 8 | H | 50 | 800 | 49 | La₂O₃ | LaTiO₃ | 4 | 7.5 | 10.7 | ∘ | |
| 9 | A | 70 | 850 | 73 | CeO₂ | CeTiO₃ | 19 | 7.8 | 12.7 | ∘ | |
| 10 | B | 50 | 940 | 363 | La₂O₃ | LaTiO₃ | 25 * | 10.8 | — | x | Comperative |
| 11 | B | 70 | 860 | 285 | Sr(OH)₂ | SrTiO₃ | 22 * | 10.5 | 20.9 | x | example |
| 12 | B | 60 | 730 | 22 | La₂O₃ | LaTiO₃ | 0.5 * | 7.2 | 21.1 | x | |
| 13 | B | 80 | 860 | 37 | Al₂O₃ | Al₂O₃ | 10 | 353 | 588 | x | |

* indicates that conditions do not satisfy those defined by the present invention.

When applying the aqueous dispersion of a sot onto the titanium sheet, as the compound contained in the sol (shown in the “Coated compound” column in Table 2), two kinds of oxide or hydroxide were used for the titanium products of Test Nos. 2 and 4, and one kind of oxide was used for the other titanium products. In Test Nos. 2 and 4, the mixing ratio between the two kinds of oxide or hydroxide was set as a mass ratio of 5:1 between the substance described first in the aforementioned column and the substance described second. It was anticipated that CeTiO₃ formed in the titanium product of Test No. 2 and SrTiO₃ formed in the titanium product of Test No. 4 would be doped with La.

Test Nos. 1 to 9 are example embodiments of the present invention. The respective films (complex oxide films) formed on the surface of these titanium products contained a complex oxide of Ti and any of La, Ce, Nd, Sr and Ca as a main constituent, and had a thickness of 1 to 20 nm. These titanium products could be favorably processed into a shape having the aforementioned grooves by press working. Further, the contact resistance of these titanium products, both initially and after operation, was adequately low for use as a separator of a polymer electrolyte fuel cell.

On the other hand, Test Nos. 10 to 13 are Comparative Examples that do not satisfy any of the requirements defined by the present invention.

In Test Nos. 10 and 11, because the thickness of the complex oxide film was more than 20 urn, the initial contact resistance became high. Further, with regard to the titanium product of Test No. 10, because the titanium product cracked during press forming, the initial contact resistance was measured for the titanium product prior to press working, and the contact resistance after battery operation was not measured. It is considered that the reason the titanium product was cracked by press forming was because, when the film thickness was enlarged, the average grain size at the base metal surface became more than 300 and the average grain size of the overall base metal also increased, and therefore the ductility of the titanium product decreased.

In Test No. 12, the contact resistance rose to a large extent after battery operation in comparison to the initial contact resistance. It is considered that this is related to the fact that the thickness of the film was less than 2 nm. In addition, in Test No. 13, both the initial contact resistance and the contact resistance after battery operation were high. In the titanium product of Test No. 13, Al₂O₃ was formed on the surface of the base metal, and a complex oxide of Ti and one or more elements selected from La, Ce, Nd, Sr and Ca was not formed thereon. It is considered that the contact resistance in Test No. 13 was high because Al₂O₃ is poor in electrical conductivity.

### Example 2

An aqueous dispersion of La₂O₃ sol was applied onto a titanium sheet obtained by subjecting an ingot of starting material E in Table 1 to cold rolling in which the rolling reduction was 80%. The applied amount of the sol aqueous dispersion was, as the mass of La₂O₃, 0.1 g/m² per side of the titanium sheet. The titanium sheet was dried, and thereafter annealed at 750° C. in an atmosphere of a gaseous mixture containing 95 vol % nitrogen and 5 vol % hydrogen. The surface of the titanium sheet was measured by thin film X-ray diffraction, and LaTiO₃ was detected. The thickness of the surface film when measured by the method described above using FE-TEM was 4 nm. Further, the average grain size at the base metal surface when measured by the method described above using EBSP was 33 μm. The titanium sheet (titanium product) was covered with the following metal layer or conductive carbon material (film).

The metal layer contained one kind or two kinds of Au, Pt, Ag, Pd, Ru and Rh as a main constituent, and was formed by plating. Specifically, the following plating solutions manufactured by Electroplating Engineers of Japan Ltd. were used for plating of the respective metals.
Au: Temperex BHG100
Pt: Platanex 3LS
Ag: Preciousfab Ag4730
Pd: Palladex ADP720
Ru: Preciousfab Ru1000
Rh: Rhodex

The plating temperature was set to 40 to 60° C. The plating thickness was adjusted by means of the amount of current, and was made 1 to 70 nm.

The conductive carbon layers were formed by the respective methods of the following a to c.
Method a: A composition obtained by dispersing electrically conductive carbon powder into a binding agent was applied onto the surface of the titanium product, and the substance was then dried at 80° C. to form a conductive carbon layer. A composition obtained by 1/15 dilution of a PTFE dispersion solution (PTFE Dispersion D1; manufactured by Daikin Industries, Ltd.) with pure water was used as the binding agent.
Method b: The surfaces of the titanium product were subjected to vacuum deposition of carbon for 20 minutes using a vacuum deposition instrument AAH-C1080SB manufactured by Shinko Seiki Co., Ltd. By this means, a conductive carbon layer was formed.
Method c: A conductive carbon layer having electrically conductive DLC (LR-DLC) as a main constituent was formed on the surface of the titanium product by a low-energy plasma treatment performed by Plasma Ion Assist Co., Ltd.

The titanium products obtained in this manner were evaluated by the same evaluation methods with respect to the same evaluation items as in Example 1. Table 3 shows the evaluation results.

TABLE 3

| | | | Contact resistance | | |
|---|---|---|---|---|---|
| | | | (mΩ · cm²) | | |
| Test | Surface | Thickness | | After | Overall |
| No. | treatment | (nm) | Initial | operation | evaluation |
| 14 | Au plating | 10 | 5.7 | 8.6 | ◯ |
| 15 | Pt plating | 7 | 5.4 | 8.3 | ◯ |
| 16 | Ag plating | 8 | 5.0 | 8.3 | ◯ |
| 17 | Pd plating | 15 | 5.6 | 8.5 | ◯ |
| 18 | Ru plating | 5 | 5.4 | 8.4 | ◯ |
| 19 | Rh plating | 22 | 4.8 | 8.1 | ◯ |
| 20 | Method a | 33 | 4.9 | 8.5 | ◯ |
| 21 | Method b | 45 | 5.1 | 8.8 | ◯ |
| 22 | Method c | 15 | 5.2 | 8.2 | ◯ |

Test Nos. 14 to 22 each had a metal layer or a conductive carbon layer at the outermost layer. The evaluation results were good for each of these test numbers, and in comparison to the results for the example embodiments of the present invention shown in Table 2, overall the value of both the initial contact resistance and the contact resistance after battery operation decreased. That is, it was clarified that by providing a metal layer or a conductive carbon layer at the outermost layer, the contact resistance can be reduced in comparison to a case where these layers are not formed.

### REFERENCE SIGNS LIST

1: Polymer electrolyte fuel cell
5a, 5b, 21: Separator
11: Base metal
12: Complex oxide film
13: Metal layer or conductive carbon layer

1. A titanium product, comprising:
a base metal having a chemical composition consisting of, by mass %,
platinum group elements: 0 to 0.15%,
rare earth elements: 0 to 0.1%, and
a balance: Ti and impurities; and
a complex oxide film formed on a surface of the base metal, the film containing a complex oxide of Ti and one or more elements selected from La, Ce, Nd, Sr and Ca, and having a thickness of 1 to 20 nm.

2. The titanium product according to claim 1, wherein
the chemical composition of the base metal contains, by mass %,
the platinum group elements: 0.005 to 0.15%.

3. The titanium product according to claim 1, wherein
the chemical composition of the base metal contains, by mass %,
the rare earth elements: 0.005 to 0.1%.

4. The titanium product according to claim 1, wherein
an average grain size at the surface of the base metal is 20 to 300 μm.

5. The titanium product according to claim 1, wherein
the titanium product has, at an outermost layer, a metal layer containing one or more elements selected from Au, Pt, Ag, Pd, Ru and Rh as a main constituent and having a thickness of 2 to 50 nm.

6. The titanium product according to claim 1, wherein
the titanium product has, at an outermost layer, a conductive carbon layer containing conductive carbon as a main constituent and having a thickness of 2 to 50 nm.

7. A separator for a polymer electrolyte fuel cell, which comprises the titanium product according to claim 1.

8. A polymer electrolyte fuel cell, which comprises the separator according to claim 7.

9. The titanium product according to claim 4, wherein
the titanium product has, at an outermost layer, a metal layer containing one or more elements selected from Au, Pt, Ag, Pd, Ru and Rh as a main constituent and having a thickness of 2 to 50 nm.

10. The titanium product according to claim 4, wherein
the titanium product has, at an outermost layer, a conductive carbon layer containing conductive carbon as a main constituent and having a thickness of 2 to 50 nm.

11. A separator for a polymer electrolyte fuel cell, which comprises the titanium product according to claim 4.

12. A separator for a polymer electrolyte fuel cell, which comprises the titanium product according to claim 5.

13. A separator for a polymer electrolyte fuel cell, which comprises the titanium product according to claim 6.

14. A separator for a polymer electrolyte fuel cell, which comprises the titanium product according to claim 9.

15. A separator for a polymer electrolyte fuel cell, which comprises the titanium product according to claim 10.

16. A polymer electrolyte fuel cell, which comprises the separator according to claim 11.

17. A polymer electrolyte fuel cell, which comprises the separator according to claim 12.

18. A polymer electrolyte fuel cell, which comprises the separator according to claim 13.

19. A polymer electrolyte fuel cell, which comprises the separator according to claim 14.

20. A polymer electrolyte fuel cell, which comprises the separator according to claim 15.
